(19) United States
(12) Patent Application Publication
(10) Pub. No.: US 2026/0034928 A1
(43) Pub. Date: Feb. 5, 2026

(54) SPOILER STRUCTURE FOR MOUNTING CENTER HIGH-MOUNTED STOP LAMP

(71) Applicant: Honda Motor Co., Ltd., Tokyo (JP)

(72) Inventors: TIMOTHY LAMPREY, HILLIARD, OH (US); TIMOTHY J. RUPP, DUBLIN, OH (US)

(21) Appl. No.: 18/794,973

(22) Filed: Aug. 5, 2024

(51) Int. Cl. B60Q 1/26; B62D 35/00

(52) U.S. Cl. CPC B60Q 1/2615; B62D 35/007

(57) ABSTRACT

A spoiler structure for a vehicle is provided. The spoiler structure includes an upper panel that includes an extended segment that is configured to be mounted on a rear portion of the vehicle. The spoiler structure further includes a lower panel that is coupled to an end segment of the upper panel. The spoiler structure further includes an inner panel that is disposed along the extended segment of the upper panel and a first portion of the lower panel such that a space is formed between the inner panel and the lower panel that is configured to include at least one sensor unit. The spoiler structure further includes a bracket that is detachably attached to a first surface of the inner panel using a plurality of fasteners.

### BACKGROUND

A vehicle spoiler, also known as a vehicle's wing in some regions, is a distinctive automotive design feature used in various vehicles over the years. The vehicle spoiler is designed to increase a vehicle's aerodynamics and reduce overall drag by generating downforce as air passes around it, and not simply disrupt existing airflow patterns. In some instances, the vehicle spoiler is found to be particularly effective in improving the handling and stability of a vehicle, especially at high speeds and during cornering. The vehicle spoilers are designed to change airflow above, around, and underneath vehicles to reduce wind resistance (or drag) or use the air to create more downforce and enable more grip at high speeds. Most of the spoilers are installed on a rear portion of the vehicle above the trunk, on a rear window, on a roof, or on a front portion of the vehicle. The vehicle spoiler may include a center high-mounted stop lamp (CHMSL) that is mounted on a center line of the rear portion of the vehicle, generally higher than stop lamps on either sides of the vehicle. The CHMSL is typically activated when a driver applies a brake. In some instances, installation of the CHMSL within the vehicle spoiler may complicate a process of servicing the CHMSL. In order to service the CHMSL, the entire spoiler may need to be replaced, leading to high cost for servicing the CHMSL. This necessitates developing a spoiler structure having an additional attachment features that may be removed easily to service the CHMSL. The structure must improve assembly quality and reduce cost of serviceability of the CHMSL.

Further limitations and disadvantages of conventional and traditional approaches will become apparent to one of skill in the art, through comparison of described systems with few aspects of the present disclosure, as set forth in the remainder of the present application and with reference to the drawings.

### SUMMARY

According to an aspect of the disclosure, a spoiler structure for a vehicle may be provided. The spoiler structure may include an upper panel that may include an extended segment configured to be mounted on a rear portion of the vehicle. The spoiler structure may further include a lower panel that may be coupled to an end segment of the upper panel. The spoiler structure may further include an inner panel that may be disposed along the extended segment of the upper panel and a first portion of the lower panel such that a space is formed between the inner panel and the lower panel. The space may be configured to include at least one sensor unit. The spoiler structure may further include a bracket that may be detachably attached to a first surface of the inner panel using a plurality of fasteners.

According to another aspect of the disclosure, a vehicle body having a spoiler structure may be provided. The spoiler structure may include an upper panel that may include an extended segment that may be configured to be mounted on a rear portion of the vehicle. The spoiler structure may further include a lower panel that may be coupled to an end segment of the upper panel. The spoiler structure may further include an inner panel that may be disposed along the extended segment of the upper panel and a first portion of the lower panel such that a space is formed between the inner panel and the lower panel. The space may be configured to include at least one sensor unit. The spoiler structure may further include a bracket that may be detachably attached to a first surface of the inner panel using a plurality of fasteners.

According to yet another aspect of the disclosure, a method of assembling a spoiler structure for a vehicle may be provided. The method may include coupling a lower panel to an end segment of an upper panel. Further, an extended segment of the upper panel may be mounted on a rear portion of the vehicle. The method may further include disposing an inner panel along the extended segment of the upper panel and a first portion of the lower panel such that a space is formed between the inner panel and the lower panel. Further, the space may be configured to include at least one sensor unit. The method may further include detachably attaching a bracket to a first surface of the inner panel using a plurality of fasteners.

### BRIEF DESCRIPTION OF THE DRAWINGS

FIG. 1 is a diagram that illustrates an exemplary vehicle having a spoiler structure, in accordance with an embodiment of the disclosure.

FIG. 2 is a diagram that illustrates an exemplary spoiler structure about a A-A section of the spoiler structure of FIG. 1, in accordance with an embodiment of the disclosure.

FIG. 3 is a diagram that illustrates cross sectional view of a spoiler structure about a B-B section and a C-C section of the spoiler structure of FIG. 1, in accordance with an embodiment of the disclosure.

FIG. 4 is a diagram that illustrates stages involved in detachably attaching a bracket to the spoiler structure of FIG. 1, in accordance with an embodiment of the disclosure.

FIG. 5 is a scenario diagram that illustrates removal of a sensor unit from the spoiler structure of FIG. 1, in accordance with an embodiment of the disclosure.

FIG. 6 is a flowchart that illustrates an exemplary method of assembling a spoiler structure for a vehicle, in accordance with an embodiment of the disclosure.

The foregoing summary, as well as the following detailed description of the present disclosure, is better understood when read in conjunction with the appended drawings. To illustrate the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

Reference will now be made in detail to specific aspects or features, examples of which are illustrated in the accompanying drawings. Wherever possible, corresponding, or similar reference numbers will be used throughout the drawings to refer to the same or corresponding parts.

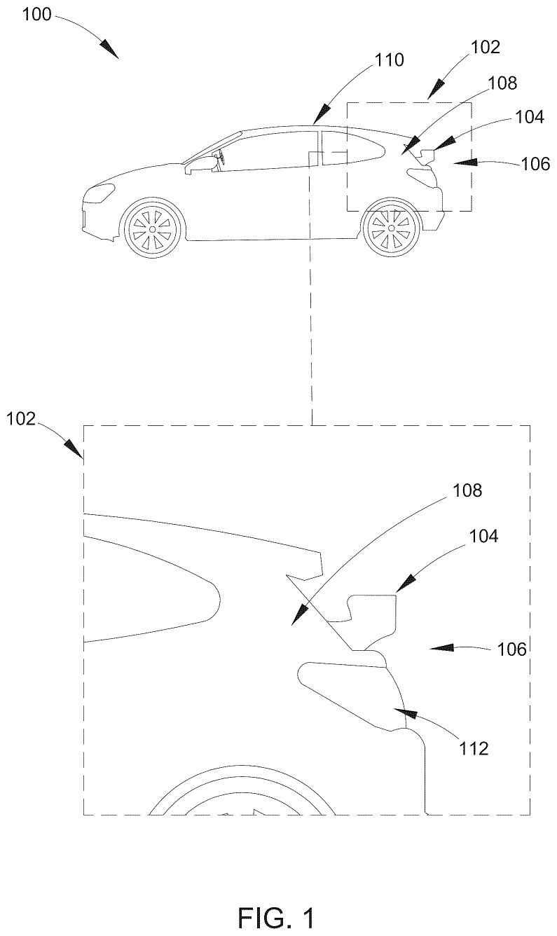

FIG. 1 is a diagram that illustrates an exemplary vehicle having a spoiler structure, in accordance with an embodiment of the disclosure. With reference to the FIG. 1, there is shown a diagram that illustrates a vehicle 100 having a vehicle body portion 102. The vehicle 100 may include a spoiler structure 104 disposed on a rear portion 106 of the vehicle 100. The vehicle 100 may further include a rear edge 108 of a roof 110.

The vehicle 100 may be a means of transport with a spoiler structure (for example, the spoiler structure 104). The spoiler structure may reduce air drag, resulting in increased efficiency of the vehicle 100. The spoiler structure may be mounted on a trunk of the vehicle 100 near a rear facing windshield of the vehicle 100. Additionally, or alternatively, the spoiler structure may be mounted underneath a front bumper of the vehicle 100 near a front bonnet of the vehicle 100. The spoiler structure may be configured to reduce the drag and lift of the vehicle 100. Examples of the vehicle 100 may include, but are not limited to, a four-wheeler vehicle, a three-wheeler vehicle, or a hybrid vehicle. Examples of the four-wheeler vehicle may include, but are not limited to, an electric vehicle, an internal combustion engine (ICE)-based vehicle, a fuel-cell based vehicle, a solar powered-vehicle, or a hybrid vehicle. It should be noted here that the vehicle body portion 102 of the four-wheeler vehicle is merely shown as an example in FIG. 1. The present disclosure may also be applicable to other types of vehicle (for example, a three-wheeled vehicle, and alike). The description of other types of the vehicle 100 has been omitted from the disclosure for the sake of brevity. Further, the vehicle 100 may include a vehicle body that may be rear section of the vehicle 100. The vehicle body may include the spoiler structure 104.

The spoiler structure 104 may be a support structure disposed on an edge of the vehicle 100, on either a front portion (not shown) or a rear portion 106 of the vehicle 100. The spoiler structure 104 may be an aerodynamic structure designed to “spoil” unfavorable air movement (such as air drag, air turbulence, or lift) across the body of the vehicle 100 in motion. As an example, the spoiler structure 104 may be frequently installed on high speed and high-performance sports vehicles. In some instances, the spoiler structure 104 may be on passenger vehicles. Additionally, the spoiler structure 104 may be disposed on the vehicle 100 for aesthetic reasons. The spoiler structure 104 may be disposed on a rear portion 106 of the vehicle 100, as shown in FIG. 1. The spoiler structure 104 may be disposed on the rear edge 108 of the roof 110 of the vehicle 100. The rear edge 108 of the roof 110 of the vehicle 100 may be extension of a roof of the vehicle 100 towards a rear facing windshield of the vehicle 100. The spoiler structure 104 may be disposed on the rear edge 108 of the roof 110 of the vehicle 100 using at least one of screws and nuts, rivet, seal, glue, or hinge. The vehicle 100 may include a taillight 112.

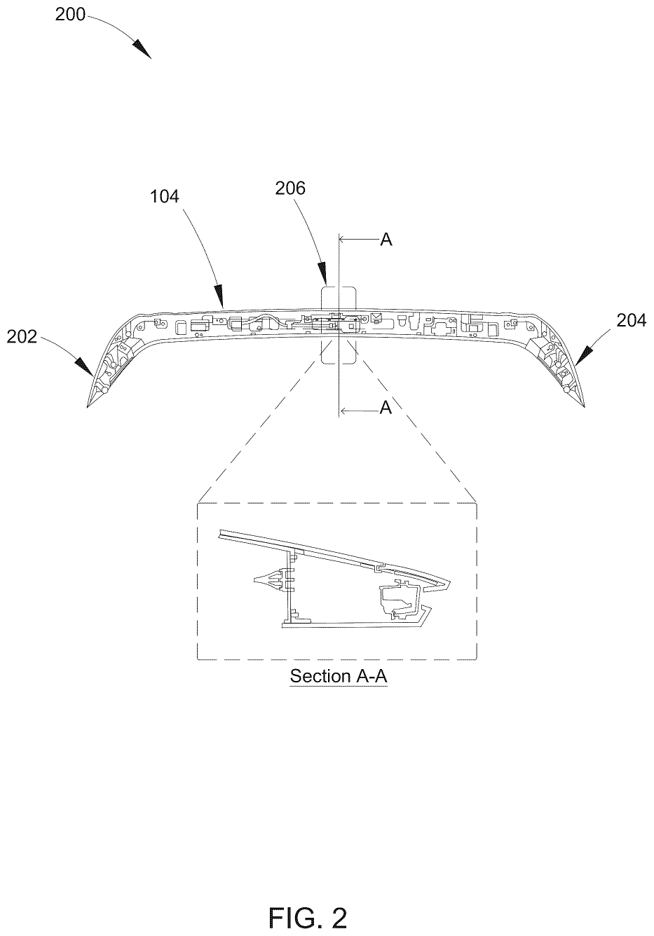

FIG. 2 is a diagram that illustrates an exemplary spoiler structure about a A-A section of the spoiler structure of FIG. 1, in accordance with an embodiment of the disclosure. FIG. 2 is explained in conjunction with elements from FIG. 1. With reference to the FIG. 2, there is shown a diagram 200 that illustrates an inside view of the spoiler structure 104 from the rear portion 106 of the vehicle 100. The diagram 200 illustrates the spoiler structure 104 about the A-A section.

The spoiler structure 104 may include a first end 202 and a second end 204 which may be different from the first end 202. The A-A section may be across a middle portion 206 of the spoiler structure 104. The middle portion 206 may be between the first end 202 and the second end 204. Additionally, or alternatively, the middle portion 206 may be near the first end 202 of the spoiler structure 104. Further, the middle portion 206 may be near the second end 204 of the spoiler structure 104. It should be further noted that the diagram 200 of FIG. 2 is for exemplary purposes and should not be construed to limit the scope of the disclosure.

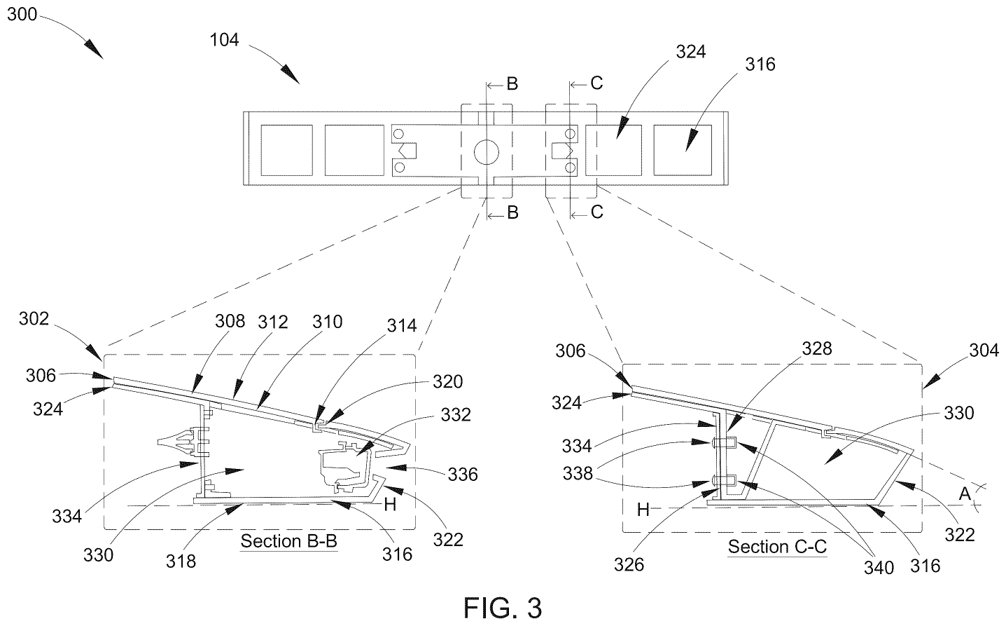

FIG. 3 is a diagram that illustrates cross sectional view of a spoiler structure about a B-B section and a C-C section of the spoiler structure of FIG. 1, in accordance with an embodiment of the disclosure. FIG. 3 is explained in conjunction with elements from FIG. 1 and FIG. 2. With reference to the FIG. 3, there is shown a diagram 300 that illustrates the spoiler structure 104 from the rear portion 106 of the vehicle 100. The diagram 300 illustrates a first cross section 302 of the spoiler structure 104 about the B-B section. The B-B section may be across the middle portion 206 of the spoiler structure 104. The diagram 300 further illustrates a second cross section 304 the spoiler structure 104 about the C-C section. The C-C section may be across at least one of the first end 202 or the second end 204 of the spoiler structure 104.

The spoiler structure 104 may include an upper panel 306 and an extended segment 308 having a first surface portion 310 and a second surface portion 312. The spoiler structure 104 may further include an end segment 314 and a lower panel 316 having a first portion 318, an end portion 320, and a second portion 322. The spoiler structure 104 may further include an inner panel 324 having a first surface 326 and a second surface 328. The spoiler structure 104 may further include a space 330, a sensor unit 332, a bracket 334, and an aperture 336. The spoiler structure 104 may further include a plurality of fasteners 338 and a plurality of slots 340.

The upper panel 306 may be an assortment of a large metal section installed on the rear portion 106 of the vehicle 100 to provide an additional support structure to mount the spoiler structure 104. The upper panel 306 may be stretched along a length of the spoiler structure 104. For example, the upper panel 306 may be at an angle “A” with a horizontal plane “H”. A cross section of the upper panel 306 of the spoiler structure 104 may have a substantially rectangular shape. Alternatively, the cross section of the upper panel 306 of the spoiler structure 104 may be formed to have another shape (for example, a substantially square shape, a substantially circular shape, a substantially semi-circular shape, and the like), without a departure from the scope of the present disclosure. Additionally, the upper panel 306 may provide a structural support to the spoiler structure 104 that may be mounted on the rear portion 106 of the vehicle 100. The upper panel 306 may include the extended segment 308 and the end segment 314.

The extended segment 308 may be an extension that may be configured to be mounted on the rear portion 106 of the vehicle 100. The extended segment 308 of the upper panel 306 may be configured to mount the spoiler structure 104 with the rear portion 106 of the vehicle 100. It should be noted here that a cross section of the extended segment 308 may have a rectangular shape, as shown in FIG. 3, for example. Alternatively, the extended segment 308 may be formed to have another shape (for example, a substantially square shape, a substantially circular shape, a substantially semi-circular shape, and the like), without a departure from the scope of the present disclosure. Further, the extended segment 308 may be extended to the end segment 314 of the upper panel 306. The extended segment 308 may have the first surface portion 310 and the second surface portion 312 that may be different from the first surface portion 310. The second surface portion 312 may be opposite to the first surface portion 310 and may be exposed to a surrounding environment. The first surface portion 310 may be configured to receive the inner panel 324.

The end segment 314 may be substantially perpendicular to the extended segment 308 of the upper panel 306. The end segment 314 may be an extension that may extend from the extended segment 308 of the upper panel 306 and may bend towards the first portion 318 of the lower panel 316. It should be noted here that the L shape of the end segment 314, as shown in FIG. 3, is merely an example. The end segment 314 may be configured to receive the end portion 320 of the lower panel 316. For example, the end segment 314 may form a rectangular cavity that may be configured to receive the end portion 320 of the lower panel 316. Additionally, the end segment 314 may reduce a gap between the end segment 314 and the end portion 320 of the lower panel 316 to firmly secure the upper panel 306 with the lower panel 316.

The lower panel 316 may be an assortment of large metal section coupled to the end segment 314 of the upper panel 306. The lower panel 316 may be an extension that may extend from the extended segment 308 of the upper panel 306. The L shape of the lower panel 316, as shown in FIG. 3, is merely an example. The lower panel 316 may have the first portion 318 which may be substantially parallel to the upper panel 306. It should be noted here that a cross section of the first portion 318 of the lower panel 316 may have a rectangular shape, as shown in FIG. 3, for example. Alternatively, the first portion 318 may be formed to have another shape (for example, a substantially square shape, a substantially circular shape, a substantially semi-circular shape, and the like), without a departure from the scope of the present disclosure. The first portion 318 may be configured to receive the inner panel 324, as shown about the C-C section.

The lower panel 316 may further include the end portion 320 which may be an extension that may be accommodated within a rectangular cavity formed by the end segment 314 of the upper panel 306. The lower panel 316 may be stretched along a length of the spoiler structure 104. The end portion 320 of the lower panel 316 may be configured to be flushed with the end segment 314 of the upper panel 306. The flushing of the end portion 320 with the end segment 314 may firmly secure the upper panel 306 with the lower panel 316. Further, an engagement of the end segment 314 of the upper panel 306 with the end portion 320 of the lower panel 316 together may form a support structure that may be configured to provide a structural support to the spoiler structure 104. In accordance with an embodiment, the end segment 314 of the upper panel 306 may be disengaged from the end portion 320 of the lower panel 316. The disengagement of the end segment 314 of the upper panel 306 from the end portion 320 of the lower panel 316 may be configured to disassemble the spoiler structure 104.

The lower panel 316 may further include the second portion 322 that may be different from the first portion 318 and the end portion 320 of the lower panel 316. The second portion 322 may extend substantially at an angle with respect to the first portion 318 of the lower panel 316. The first portion 318 and the second portion 322 may together provide an L shape to the lower panel 316. The second portion 322 may include the aperture 336 about the B-B section of the spoiler structure 104. Additionally, the second portion 322 may be a continuous extension about the C-C section of the spoiler structure 104. The aperture 336 may provide a passage for a transmission of a light or a radio signal from the sensor unit 332.

The inner panel 324 may be an assortment of large metal section that may be disposed along the extended segment 308 of the upper panel 306 and the first portion 318 of the lower panel 316. The inner panel 324 may be disposed on the first surface portion 310 of the extended segment 308 and may be stretched along a length of the spoiler structure 104. The inner panel 324 may have a cut section across the aperture 336 about the B-B section of the spoiler structure 104 and may be continuous about the C-C section of the spoiler structure 104. The inner panel 324 may be disposed along the extended segment 308 of the upper panel 306 and the first portion 318 of the lower panel 316 such that the space 330 is formed between the inner panel 324 and the lower panel 316. The space 330 may be configured to include at least one sensor unit 332. As an example, the space 330 may be a vacant area surrounded by the inner panel 324 and the lower panel 316. By way of example, and not limitation, the space 330 may form an irregular shape based on a shape and dimensions of the inner panel 324 and the lower panel 316.

The inner panel 324 may further include the first surface 326 and the second surface 328. The first surface 326 may face towards the bracket 334 and may be in a direct contact with the bracket 334. The second surface 328 may face towards the space 330 formed between the inner panel 324 and the lower panel 316.

The sensor unit 332 may include suitable logic, circuitry, interfaces, and/or code that may transmit a light or a radio signal. The transmission of the light or radio signal may be based on an application of brakes of the vehicle 100. Further, the light or radio signal transmitted from the sensor unit 332 may pass from the aperture 336. In an example embodiment, the sensor unit 332 may be a center high-mounted stop lamp (CHMSL). The CHMSL may be a third brake light or eye-level brake light mounted higher than the taillight 112 (as shown in FIG. 1) of the vehicle 100. The CHMSL may be intended to keep other drivers, whose sight of the vehicle's left and right stop lights is obstructed by interceding vehicles, aware of slowing down or stopping of the vehicle 100. As an example, the CHMSL may provide a redundant stop light signal in an event of a brake light failure.

The bracket 334 may be a metal fitting structure that may be used to enclose the sensor unit 332 included in the space 330. The bracket 334 may provide an increased strength to the spoiler structure 104 and may be detachably attached to the first surface 326 of the inner panel 324 using the plurality of fasteners 338. The bracket 334 may have a substantially rectangular shape. Alternatively, the bracket 334 may be formed to have another shape (for example, a substantially square shape, a substantially circular shape, a substantially semi-circular shape, and the like), without a departure from the scope of the present disclosure. Additionally, the bracket 334 may provide a structural support to the spoiler structure 104. By way of example, and not limitation, the bracket 334 may be a single piece metal fitting structure. Additionally, the bracket 334 may include a plurality of metal fitting structures such a male portion and a female portion. As an example, the bracket 334 may be attached to seal the sensor unit 332 inside the space 330. As another example, the bracket 334 may be detached to allow a user to access the sensor unit 332.

The plurality of fasteners 338 may be metal components that bind one surface to another. Each fastener of the plurality of fasteners 338 may be a mechanical component that securely joins or attaches two or more surfaces together. As an example, the plurality of fasteners 338 may include screws, bolts, or rivets. Other examples of the plurality of fasteners 338 may include nuts, washers, pins, clips, and anchors.

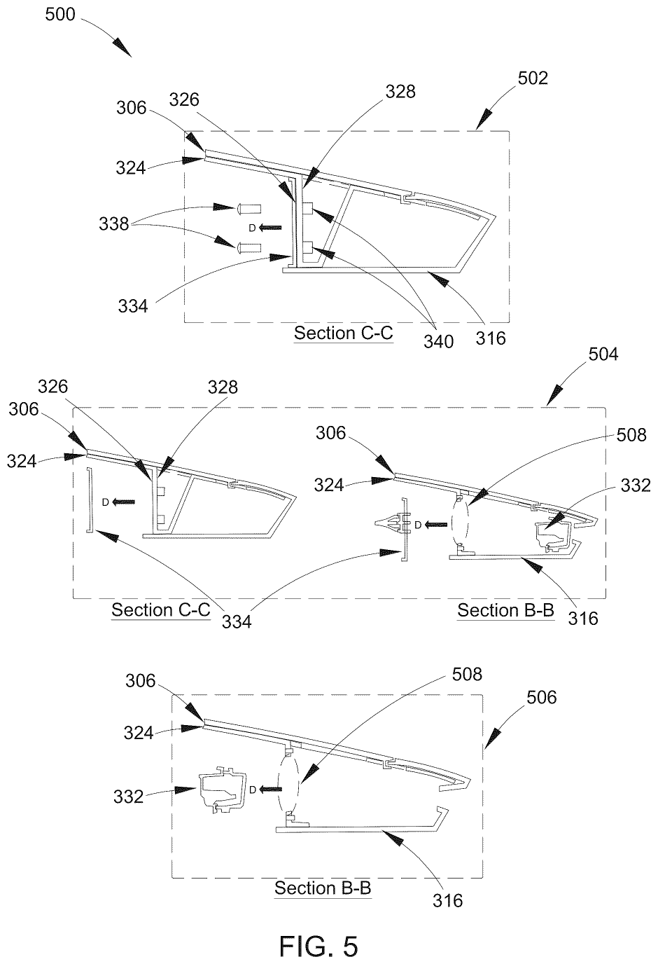

The plurality of fasteners 338 may be fastened against the bracket 334 to firmly hold the bracket 334 against the first surface 326 of the inner panel 324. The second surface 328 of the inner panel 324 may include the plurality of slots 340 that may be configured to accommodate the plurality of fasteners 338. The plurality of slots 340 may be used to accommodate the plurality of fasteners 338, in a direction that is opposite to a direction “D”, as described in detail, for example, in FIG. 5. In accordance with an embodiment, when the bracket 334 is to be detached from the spoiler structure 104, the plurality of fasteners 338 may be detached from the plurality of slots 340, in the direction “D”, as described in detail, for example, in FIG. 5. Further, a removal of the plurality of fasteners 338 may cause the bracket 334 to disengage from the inner panel 324.

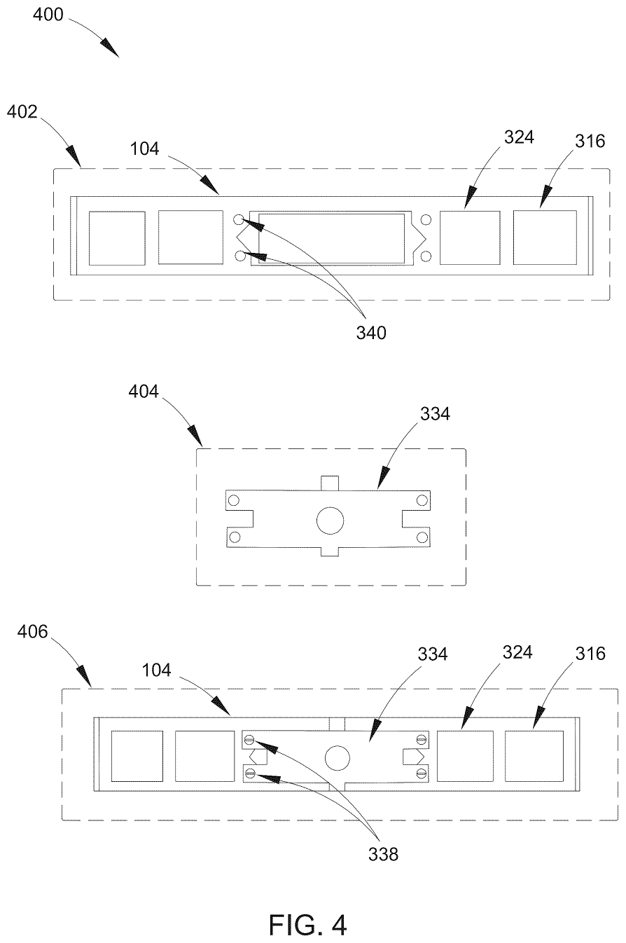

FIG. 4 is a diagram that illustrates stages involved in detachably attaching a bracket to the spoiler structure of FIG. 1, in accordance with an embodiment of the disclosure. FIG. 4 is explained in conjunction with elements from FIG. 1, FIG. 2, and FIG. 3. With reference to the FIG. 4, there is shown a diagram 400 that illustrates the end segment 314 from the rear portion 106 of the vehicle 100. The diagram 400 may include a first stage 402, a second stage 404, and a final stage 406.

In the first stage 402, the spoiler structure 104 may not include the bracket 334. The spoiler structure 104 may include the lower panel 316 and the inner panel 324. The spoiler structure 104 may further include the plurality of slots 340 which may not include the plurality of fasteners 338.

In the second stage 404, the bracket 334 may be picked up by a user to be detachably attached to the first surface 326 of the inner panel 324.

In the final stage 406, the spoiler structure 104 may include the bracket 334. The bracket may be detachably attached to the first surface 326 of the inner panel 324. Further, the plurality of fasteners 338 may be accommodated inside the plurality of slots 340.

It should be further noted that the diagram 400 of FIG. 4 is for exemplary purposes and should not be construed to limit the scope of the disclosure.

FIG. 5 is a scenario diagram that illustrates removal of a sensor unit from the spoiler structure of FIG. 1, in accordance with an embodiment of the disclosure. FIG. 5 is explained in conjunction with elements from FIG. 1, FIG. 2, FIG. 3, and FIG. 4. With reference to the FIG. 5, there is shown a scenario diagram 500 that may include a first scenario 502, a second scenario 504, a third scenario 506, and an opening 508.

In first scenario 502, the plurality of fasteners 338 may be removed from the plurality of slots 340 in a direction “D”. As an example, the direction “D” may be a direction opposite to a direction of movement of the vehicle 100. As another example, the direction “D” may be a direction towards a rear portion 106 of the vehicle 100. The bracket 334 may be detached from the first surface 326.

In second scenario 504, the bracket 334 may be removed from the first surface 326 of the inner panel 324. Further, a disengagement of the bracket 334 from the inner panel 324 may provide the opening 508 about the B-B section of the spoiler structure 104. The opening 508 may be aligned with the sensor unit 332.

In third scenario 506, the sensor unit 332 may be removed from the spoiler structure 104 via the opening 508. The sensor unit 332 may be removed from the spoiler structure 104 without requiring a replacement or uninstallation of the spoiler structure 104 from the vehicle 100, resulting in improved assembly quality. The removal may be done for repair or replacement. After the repair or replacement is done, the sensor unit 332 may be installed inside the spoiler structure 104 via the opening 508 and the bracket 334 may be detachably attached to the inner panel 324 of spoiler structure 104. Additionally, without requiring the replacement or uninstallation of the spoiler structure 104, a cost of serviceability of the sensor unit 332 may be reduced.

It should be noted that the scenario diagram 500 shown in FIG. 5 is for exemplary purposes and should not be construed to limit the scope of the disclosure.

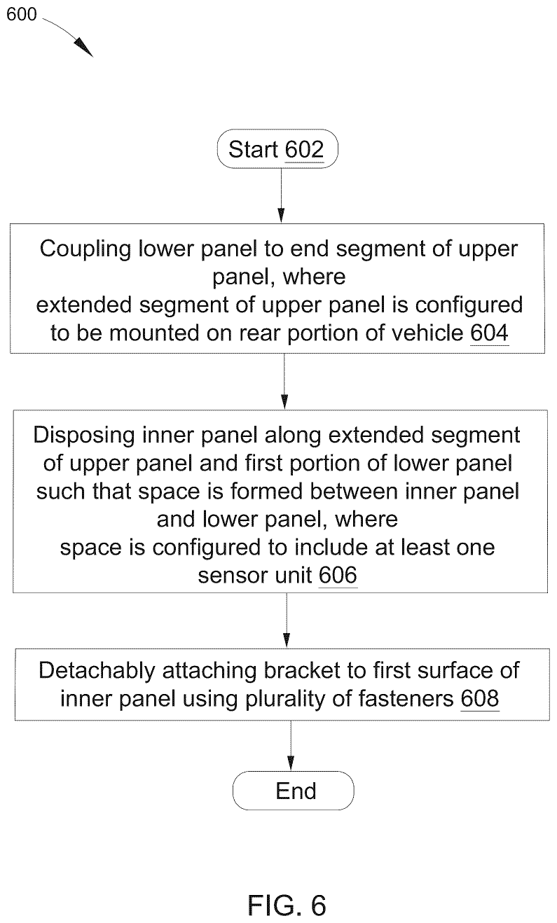

FIG. 6 is a flowchart that illustrates an exemplary method of assembling a spoiler structure for a vehicle, in accordance with an embodiment of the disclosure. FIG. 6 is explained in conjunction with elements from FIG. 1, FIG. 2, FIG. 3, FIG. 4, and FIG. 5. With reference to FIG. 6, there is shown a flowchart 600, which may depict a method of assembling the spoiler structure 104 for the vehicle 100. The method illustrated in the flowchart 600 may start at 602 and proceed to 604.

At 604, the lower panel 316 may be coupled to the end segment 314 of the upper panel 306. Further, the extended segment 308 of the upper panel 306 may be configured to be mounted on a rear portion 106 of the vehicle 100, as described, in detail, for example, in FIG. 1, FIG. 2, and FIG. 3.

At 606, the inner panel 324 may be disposed along the extended segment 308 of the upper panel 306 and the first portion 318 of the lower panel 316 such that the space 330 is formed between the inner panel 324 and the lower panel 316. The space 330 may include the at least one sensor unit 332, as described in detail, for example, in FIG. 1, FIG. 2, and FIG. 3.

At 608, the bracket 334 may be detachably attached to the first surface 326 of the inner panel 324 using the plurality of fasteners 338, as described in detail, for example, in FIG. 1, FIG. 2, FIG. 3, and FIG. 4.

Although the flowchart 600 is illustrated as discrete operations, such as 602, 604, 606, and 608, the disclosure is not so limited. Accordingly, in certain embodiments, such discrete operations may be further divided into additional operations, combined into fewer operations, or eliminated, depending on the particular implementation without detracting from the essence of the disclosed embodiments.

For the purposes of the present disclosure, expressions such as “including”, “comprising”, “incorporating”, “consisting of”, “have”, “is” used to describe and claim the present disclosure are intended to be construed in a non-exclusive manner, namely allowing for items, components or elements not explicitly described also, to be present. Reference to the singular is also to be construed to relate to the plural. Further, all joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

The foregoing description of embodiments and examples has been presented for purposes of illustration and description. It is not intended to be exhaustive or limiting to the forms described. Numerous modifications are possible considering the above teachings. Some of those modifications have been discussed and others will be understood by those skilled in the art. The embodiments were chosen and described for illustration of various embodiments. The scope is, of course, not limited to the examples or embodiments set forth herein but can be employed in any number of applications and equivalent devices by those of ordinary skill in the art. Rather it is hereby intended the scope be defined by the claims appended hereto. Additionally, the features of various implementing embodiments may be combined to form further embodiments.

1. A spoiler structure for a vehicle, comprising:
an upper panel comprising an extended segment that is configured to be mounted on a rear portion of the vehicle;
a lower panel coupled to an end segment of the upper panel;
an inner panel disposed along the extended segment of the upper panel and a first portion of the lower panel such that a space formed between the inner panel and the lower panel is configured to include at least one sensor unit; and
a bracket detachably attached to a first surface of the inner panel using a plurality of fasteners.

2. The spoiler structure according to claim 1, wherein a removal of the plurality of fasteners causes the bracket to disengage from the inner panel.

3. The spoiler structure according to claim 1, wherein the spoiler structure is disposed on the rear portion of a roof down of the vehicle.

4. The spoiler structure according to claim 1, wherein the extended segment of the upper panel includes a first surface portion and a second surface portion that is exposed to a surrounding environment, and the inner panel is disposed on the first surface portion.

5. The spoiler structure according to claim 1, wherein the lower panel further includes an end portion that is flushed with the end segment of the upper panel.

6. The spoiler structure according to claim 1, wherein the lower panel further includes a second portion that extends substantially at an angle with respect to the first portion of the lower panel.

7. The spoiler structure according to claim 6, wherein the second portion of the lower panel includes an aperture that provides a passage for a transmission of a light or radio signal from the sensor unit.

8. The spoiler structure according to claim 1, wherein the inner panel further includes a second surface that includes a plurality of slots configured to accommodate the plurality of fasteners.

9. The spoiler structure according to claim 1, wherein a disengagement of the bracket from the inner panel provides an opening, and the sensor unit is configured to be removed from the spoiler structure via the opening.

10. The spoiler structure according to claim 1, wherein an engagement of the end segment of the upper panel with an end portion of the lower panel together from a support structure configured to provide a structural support to the spoiler structure.

11. The spoiler structure according to claim 1, wherein the sensor unit is a center high-mounted stop lamp (CHMSL).

12. A vehicle body, comprising:
a spoiler structure that includes:
an upper panel comprising an extended segment that is configured to be mounted on a rear portion of a vehicle;
a lower panel coupled to an end segment of the upper panel;
an inner panel disposed along the extended segment of the upper panel and a first portion of the lower panel such that a space formed between the inner panel and the lower panel is configured to include at least one sensor unit; and
a bracket detachably attached to a first surface of the inner panel using a plurality of fasteners.

13. The vehicle body according to claim 12, wherein a removal of the plurality of fasteners causes the bracket to disengage from the inner panel.

14. The vehicle body according to claim 12, wherein the extended segment of the upper panel includes a first surface portion and a second surface portion that is exposed to a surrounding environment, and the inner panel is disposed on the first surface portion.

15. The vehicle body according to claim 12, wherein the lower panel further includes an end portion that is flushed with the end segment of the upper panel.

16. The vehicle body according to claim 12, wherein the lower panel further includes a second portion that extends substantially at an angle with respect to the first portion of the lower panel.

17. The vehicle body according to claim 16, wherein the second portion of the lower panel includes an aperture that provides a passage for a transmission of a light or radio signal from the sensor unit.

18. The vehicle body according to claim 12, wherein a disengagement of the bracket from the inner panel provides an opening, and the sensor unit is configured to be removed from the spoiler structure via the opening.

19. A method of assembling a spoiler structure for a vehicle, the method comprising:
coupling a lower panel to an end segment of an upper panel, wherein, an extended segment of the upper panel is configured to be mounted on a rear portion of the vehicle;
disposing an inner panel along the extended segment of the upper panel and a first portion of the lower panel such that a space is formed between the inner panel and the lower panel, wherein, the space is configured to include at least one sensor unit; and
detachably attaching a bracket to a first surface of the inner panel using a plurality of fasteners.

20. The method according to claim 19, wherein the method further comprises a disengagement of the bracket from the inner panel to provide an opening, and the sensor unit is configured to be removed from the spoiler structure via the opening.
